(19) United States
(12) Patent Application Publication
(10) Pub. No.: US 2015/0378995 A1
(43) Pub. Date: Dec. 31, 2015

(54) MANAGING PUBLIC NOTES AND PRIVATE NOTES PERTAINING TO A DOCUMENT WHICH IS SHARED DURING AN ONLINE MEETING

(71) Applicant: Citrix Systems, Inc., Fort Lauderdale, FL (US)

(72) Inventors: Amber Brown, Santa Barbara, CA (US); AnnMarie Lock, Brooklyn, NY (US); Ashish V. Thapliyal, Santa Barbara, CA (US); Elizabeth Thapliyal, Santa Barbara, CA (US); Matthew Anderson, New York, NY (US)

(21) Appl. No.: 14/316,312

(22) Filed: Jun. 26, 2014

(51) Int. Cl. G06F 17/30; H04L 29/06

(52) U.S. Cl. CPC G06F 17/30011; H04L 65/403

(57) ABSTRACT

A technique manages notes pertaining to a document during an online meeting. The technique involves, while displaying contents of the document to participants of the online meeting, accessing, by processing circuitry, public notes and private notes pertaining to the contents of the document, the public notes and the private notes having been provided by a particular participant. The technique further involves sharing, by the processing circuitry, the public notes with other participants of the online meeting. The technique further involves concealing, by the processing circuitry, the private notes from the other participants of the online meeting.

### BACKGROUND

During a web conference, human participants connect their respective client devices (e.g., desktop computers, laptop computers, tablets, smart phones, etc.) to a web conference server over a network. A presenter may then share a screen view of the presenter's client device with attendees of the web conference. The screen view may include text from a document such as a slideshow, an editable document, a spreadsheet, and so on.

When the presenter shares the text of the document among the attendees of the web conference, the presenter may wish to add comments to that document. For example, suppose that one of the attendees provides a remark regarding a particular phrase in the document. The presenter may select that phrase and add a comment containing the attendee's remark to the selected phrase. Since the document is shared among the attendees, the attendees are able to observe the presenter's addition of the comment and follow along as the web conference progresses. Moreover, if the document is eventually stored in a centralized location, the presenter and the attendees are able to access the document text along with the added comment later on from the centralized location.

### SUMMARY

Unfortunately, there are deficiencies to the above-described conventional web conference which enables a presenter to share text from a document with attendees but also allows the attendees to observe the presenter's added comments. For example, the document may be a good vehicle for holding mental reminders or an outline to assist the presenter in making a presentation (e.g., a roadmap of what the presenter expects to discuss during the web conference). However, showing such information in the form of comments to the attendees would be distracting and detract from the user experience. Accordingly, the presenter may resort to referencing a hardcopy of the document with handwritten reminders and personal annotations manually scribbled on the hardcopy rather than use the document to store such items.

Additionally, the presenter may wish to jot down certain information such as specific thoughts for improving particular sections of the document, related ideas that are meaningful only to the presenter, and other comments gathered from the attendees which are tangential but not germane to the web conference. Such information, if shared with the attendees via comments added to the document, would only serve to further distract the focus and concentration of the attendees. Thus, the conventional document commenting function which shows comments to the attendees of the web conference is not well-suited for collecting such information.

In contrast to the above-described conventional web conference which enables attendees to observe a presenter's comments to a document, improved techniques are directed to managing access to public notes and private notes pertaining to contents of a document which, at some point during use, is displayed to participants of an online meeting. In particular, public notes provided by a particular participant are shared with other participants. However, private notes provided by the particular participant are concealed from the other participants. Since the private notes are not shared with the other participants, the private notes do not distract the other participants thus improving the user experience for all involved in the online meeting.

It should be understood that such public and private notes can be added by any participant before, during, and/or after the online meeting. For example, a particular participant such as a presenter can add private notes pertaining to the document such as a presentation roadmap ahead of time, and then conveniently refer to the presentation roadmap during the online meeting without distracting other participants with the presentation roadmap. Such a feature enables the presenter to access the roadmap and/or other private notes easily while accessing the document thus alleviating the need for the presenter to carry along a separate annotated hardcopy to use as a reference. In some arrangements, the public notes and private notes are saved as metadata for future reference, and the private notes are accessible only by the particular participant that added the private notes (e.g., via access privileges).

As another example, a reviewer who is not the presenter can review the document and add public notes and/or private notes pertaining to the document prior to the online meeting. During the online meeting, all participants can view any public notes added by the reviewer (e.g., proposed changes that the reviewer wishes the other participants to see). However, only the reviewer is able to view private notes added by the reviewer (e.g., cryptic notes that remind the reviewer about items for discussion but that would be distracting if viewed by the other participants).

One should appreciate that the use of private notes enables the contributors to conduct themselves in a manner that looks professional and well-prepared. Furthermore, such notes are easily integrated with the document thus alleviating any struggle or burden of having to carry a separate set of notes (e.g., a marked-up document). Other situations and scenarios are suitable as well.

One embodiment is directed to a method of managing notes pertaining to a document (e.g., an electronic file) during an online meeting. The method includes, while displaying contents of the document to participants of the online meeting, accessing public notes and private notes pertaining to the contents of the document, the public notes and the private notes having been provided by a particular participant. The method further includes sharing the public notes with other participants of the online meeting, and concealing the private notes from the other participants of the online meeting.

In some arrangements, the method further includes, upon conclusion of the online meeting, storing the public notes and the private notes as metadata associated with the contents of the document. Such a feature enables future note access.

In some arrangements, sharing the public notes with the other participants of the online meeting includes displaying certain text of the document in a highlighted manner to the other participants of the online meeting. In these arrangements, sharing further includes, while displaying the certain text of the document in the highlighted manner, receiving a view command from one of the other participants to view a public note pertaining to the certain text and, in response to the view command, rendering the public note pertaining to the certain text to that one of the other participants.

In some arrangements, concealing the private notes from the other participants of the online meeting includes displaying certain text of the document in a non-highlighted manner to the other participants of the online meeting. In these arrangements, concealing further includes, while displaying the certain text of the document in the non-highlighted manner to the other participants of the online meeting, receiving a view command from the particular participant to view a private note pertaining to the certain text and, in response to the view command, rendering the private note pertaining to the certain text to the particular participant and not rendering the private note pertaining to the certain text to the other participants.

In some arrangements, displaying the first text of the document in the highlighted manner to all participants of the online meeting includes rendering the first text to the particular participant in a first color. In these arrangements, displaying the second text of the document in the highlighted manner to the particular participant of the online meeting includes rendering the second text to the particular participant in a second color which is different than the first color. In certain arrangements, different colors are keyed to different people (e.g., for easy identification). However, in other arrangements, they are not (e.g., for simpler viewing).

In some arrangements, the method further includes receiving freestyle drawn notes from the particular participant and storing the freestyle drawn notes as additional metadata associated with the contents of the document to enable future access to the freestyle drawn notes. For example, a user is able to hand draw lines, words, objects, etc. over the content of the document, and such hand drawn input which may be public or private is saved for future reference.

In some arrangements, concealing the private notes from the other participants of the online meeting includes displaying a look-ahead pane to the particular participant and not displaying the look-ahead pane to the other participants, the look-ahead pane including the private notes. Such a feature may be useful to a presenter to provide roadmap input to the presenter while the presenter is presenting, but remain out of sight from attendees so as not to distract from the presentation.

In certain arrangements, the particular participant connects a local user device to an online meeting server to join the online meeting. In some arrangements, storing the public notes and the private notes as the metadata associated with the contents of the document includes saving, on the online meeting server, (i) first metadata containing the public notes, the first metadata being readable by any of the participants from the online meeting server, and (ii) second metadata containing the private notes, the second metadata being readable from the online meeting server by the particular participant and not readable from the online meeting server by the other participants. In other arrangements, storing the public notes and the private notes as the metadata associated with the contents of the document includes (i) saving first metadata containing the public notes on the online meeting server to enable reading of the first metadata by any of the participants, and (ii) saving second metadata containing the private notes on the local user device to enable reading of the second metadata by only the particular participant.

In certain arrangements, the contents of the document are displayed via a shared application. In some arrangements, storing the public notes and the private notes as the metadata associated with the contents of the document can include conveying a save command to the shared application (e.g., a document application with integrated note management capabilities) which saves the metadata in non-volatile memory in response to the save command. In other arrangements, storing the public notes and the private notes as the metadata associated with the contents of the document includes conveying a save command to another application (e.g., a separate overlay application) which overlays a shared workspace screen transparently over the contents of the document displayed via the shared application, the other application saving the metadata in non-volatile memory in response to the save command.

Another embodiment is directed to an electronic apparatus which includes a network interface, memory, and control circuitry coupled to the network interface and the memory. The memory stores instructions which, when carried out by the control circuitry, cause the control circuitry to:
(A) while displaying contents of a document to participants of an online meeting, access public notes and private notes pertaining to the contents of the document, the public notes and the private notes having been provided by a particular participant,
(B) share the public notes with other participants of the online meeting, and
(C) conceal the private notes from the other participants of the online meeting.

Yet another embodiment is directed to a computer program product having a non-transitory computer readable medium which stores a set of instructions to manage notes pertaining to a document during an online meeting. The set of instructions, when carried out by computerized circuitry, causes the computerized circuitry to perform a method of:
(A) while contents of the document are displayed to participants of the online meeting, accessing public notes and private notes pertaining to the contents of the document, the public notes and the private notes having been provided by a particular participant;
(B) sharing the public notes with other participants of the online meeting; and
(C) concealing the private notes from the other participants of the online meeting.

It should be understood that, in the cloud context, the computerized circuitry is formed by remote computer resources distributed over a network. Such a computerized environment is capable of providing certain advantages such as distribution of hosted services and resources (e.g., software as a service, platform as a service, infrastructure as a service, etc.), enhanced scalability, etc.

Other embodiments are directed to electronic systems and apparatus, processing circuits, computer program products, and so on. Some embodiments are directed to various methods, electronic components and circuitry which are involved in managing public notes and private notes pertaining to a document which is shared during an online meeting.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a computerized environment which manages public notes and private notes pertaining to a document which is shared during an online meeting.

FIG. 2 is a block diagram of a screen of a first client apparatus operated by a first online meeting participant who adds a public note and a private note pertaining to a document, and has moved a mouse cursor (or similar pointer) over a highlighted portion of text associated with the added public note.

FIG. 3 is a block diagram of a screen of a second client apparatus operated by a second online meeting participant who has moved a mouse cursor over the highlighted portion of text associated with the added public note.

FIG. 4 is a block diagram of the screen of the first client apparatus operated by the first online meeting participant who has moved the mouse cursor over a highlighted portion of text associated with the added private note.

FIG. 5 is a block diagram of the screen of the second client apparatus operated by the second online meeting participant who has moved the mouse cursor over text associated with the added private note.

FIG. 6 is a block diagram of an online meeting server apparatus of the computerized environment of FIG. 1.

FIG. 7 is a block diagram of a client apparatus of the computerized environment of FIG. 1.

FIG. 8 is a block diagram of a particular screen of the first client apparatus operated by the first online meeting participant when adding a note.

FIG. 9 is a block diagram of a particular screen of the first client apparatus operated by the first online meeting participant when adding handwritten input.

FIG. 10 is a block diagram of a particular screen of the first client apparatus operated by the first online meeting participant when using a document preview pane.

FIG. 11 is a flowchart of a procedure which is performed by the computerized setting of FIG. 1.

### DETAILED DESCRIPTION

An improved technique is directed to managing access to public notes and private notes pertaining to contents of an electronic document which, at some point during use, is displayed to participants of an online meeting. Along these lines, public notes provided by a particular participant are shared with other participants. However, private notes provided by the particular participant are concealed from the other participants. Since the private notes are not shared with the other participants, the private notes do not distract the other participants thus improving the user experience for all involved in the online meeting. It should be understood that such public notes and private notes can be added by anyone before, during, and/or after the online meeting. Moreover, such notes can be later accessed or even added after the online meeting is over or in subsequent online meetings. For example, such notes can serve as reminders before the online meeting, as cues/prompts during the online meeting, as solutions after the online meeting, and so on.

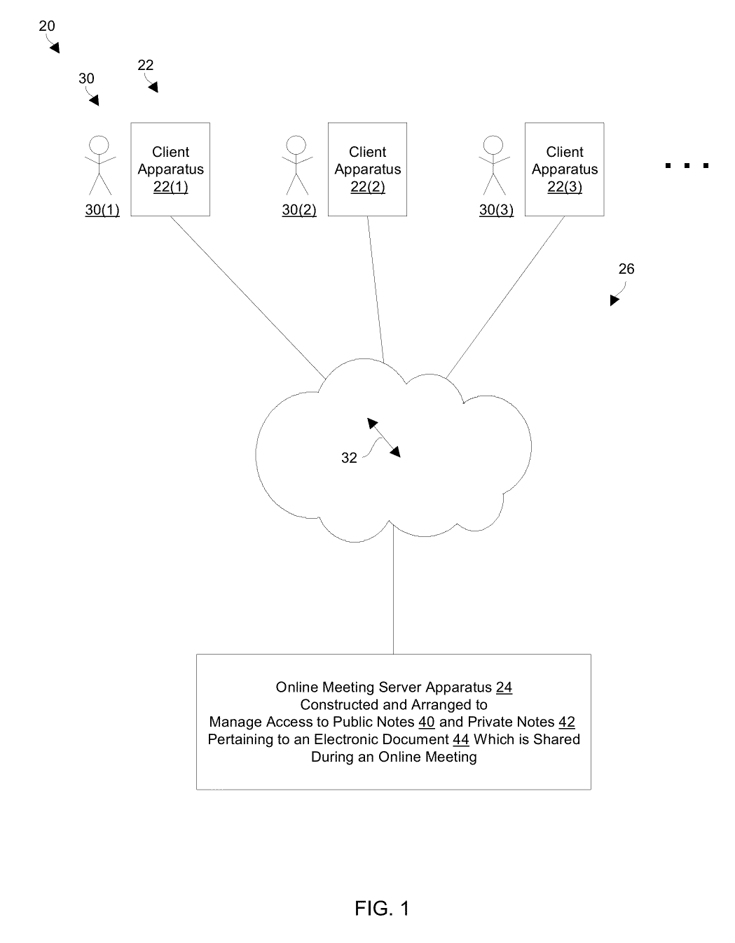

FIG. 1 shows a computerized setting 20 which manages public notes and private notes pertaining to an electronic document (e.g., a file or a set of files) which is shared during an online meeting. The computerized setting 20 includes client apparatus 22(1), 22(2), 22(3), . . . (collectively, client apparatus 22), an online meeting server apparatus 24, and communications medium 26.

Each client apparatus 22 is constructed and arranged to participate in an online meeting on behalf of a respective user 30. For example, the client apparatus 22(1) operates on behalf of a user 30(1). Similarly, the client apparatus 22(2) operates on behalf of a user 30(2), the client apparatus 22(3) operates on behalf of a user 30(3), and so on.

To this end, each client apparatus 22 includes user input/output (I/O) circuitry such as a microphone for audio input, a camera for video input, a speaker for audio output, and a display for video output. Moreover, each client apparatus 22 may include other user control mechanisms such as a keyboard, a mouse, a touch screen, and so on. Examples of standard client apparatus 22 include user workstations, desktop computers, laptop computers, tablets, smart phones, specialized conference room conferencing devices, and the like.

The online meeting server 24 is constructed and arranged to host online meetings on behalf of the users 30. The online meeting server 24 may be implemented as a set of servers (e.g., a server farm, a distributed computing environment, etc.), on a virtualized platform, in the cloud, as a peer-to-peer system, etc. To this end, the online meeting server 24 can include an online meeting engine to host multiple online meetings concurrently. For each online meeting, the online meeting server 24 shares video content and audio content among participants, i.e., users 30. Accordingly, the participants are able to view visual content, as well as inject comments and ask questions to form a collaborative exchange even though the participants may be scattered among remote locations.

The communications medium 26 is constructed and arranged to connect the various components of the computerized setting 20 together to enable the client apparatus 22 and the online meeting server apparatus 24 to exchange electronic signals 32 (e.g., see the double arrow 32). At least a portion of the communications medium 26 is illustrated as a cloud to indicate that the communications medium 26 is capable of having a variety of different topologies including backbone, hub-and-spoke, loop, irregular, combinations thereof, and so on. Along these lines, the communications medium 26 may include copper-based data communications devices and cabling, fiber optic devices and cabling, wireless devices, combinations thereof, etc. Furthermore, the communications medium 26 is capable of supporting LAN-based communications, cellular communications, plain old telephone service (POTS) based communications, combinations thereof, and so on.

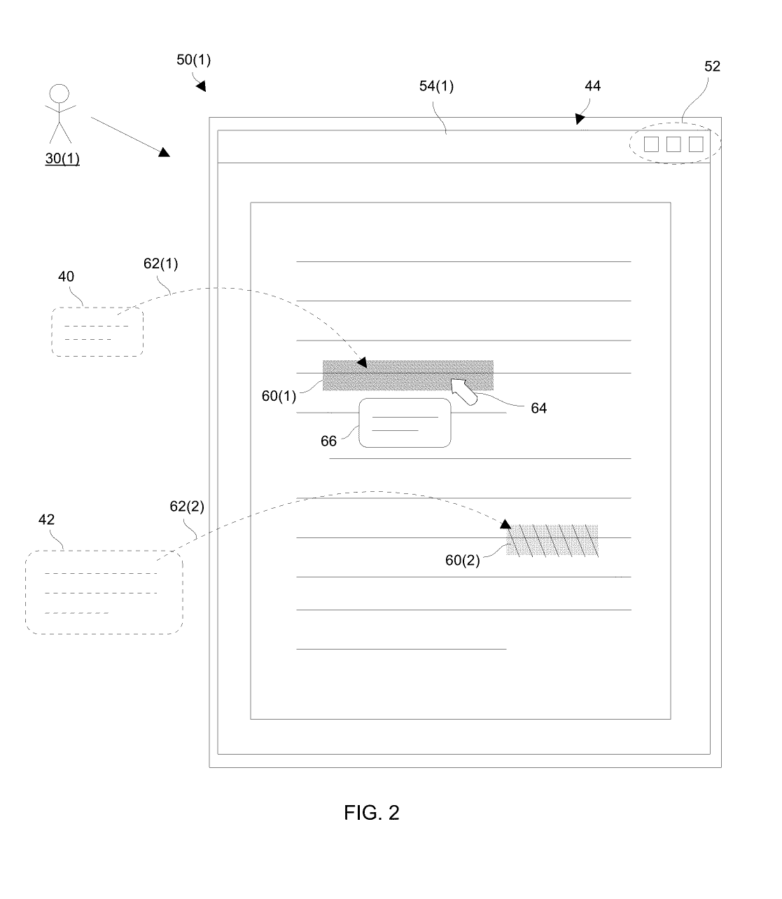

During operation, the users 30 operate their respective client apparatus 22 to join and participate in online meetings. During such a meeting, each participant is able to add public notes 40 and private notes 42 pertaining to an electronic document 44 that is shared during the online meeting. In particular, the public notes 40 are viewable by all participants of the online meeting, while the private notes 42 are only viewable by the participant that added the private notes 42. Accordingly, each participant is able to effectively engage in focused collaboration using the public notes 40 of all participants and the private notes 42 of only that participant. As a result, each participant is not distracted by the private notes 42 of the other participants. Further details will now be provided with reference to FIGS. 2-5.

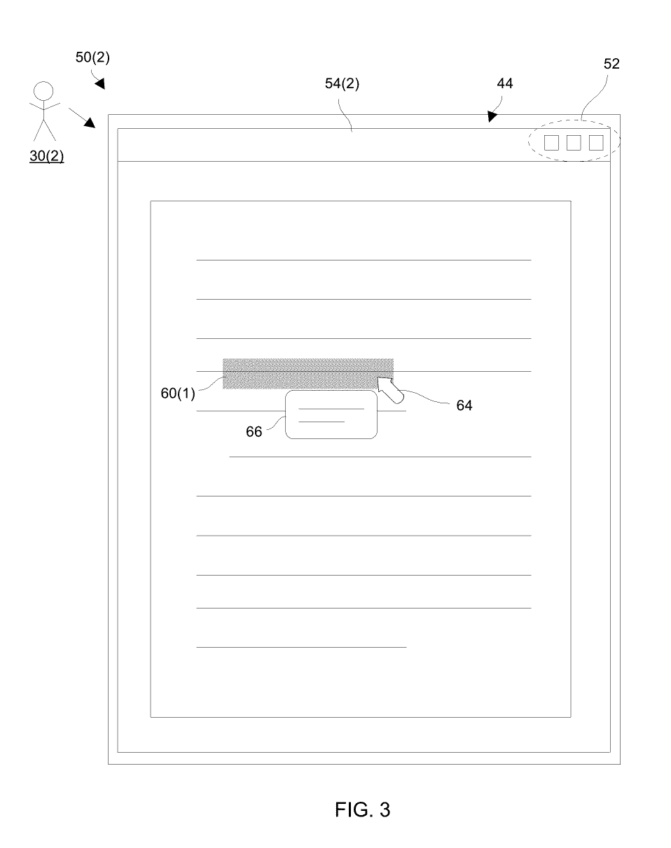

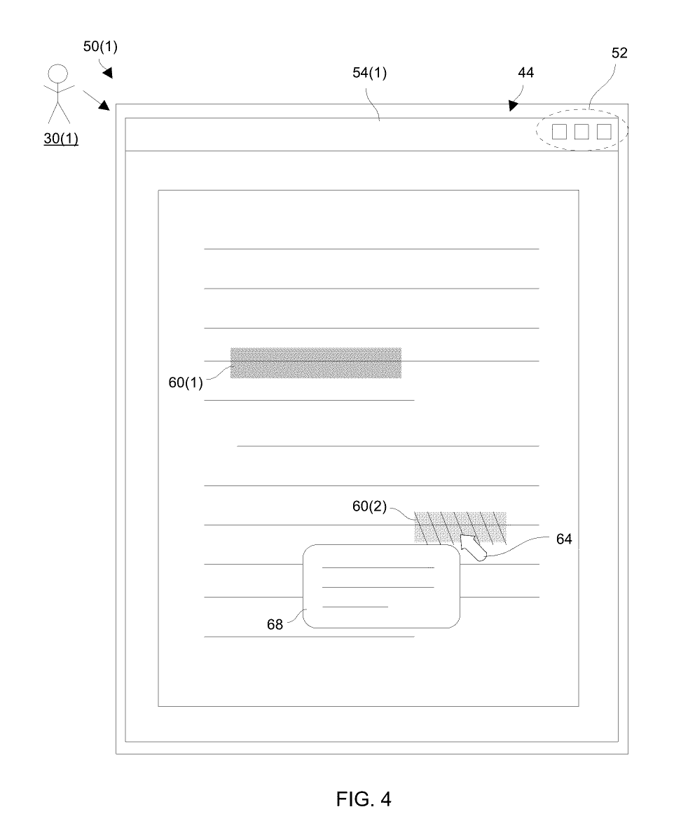

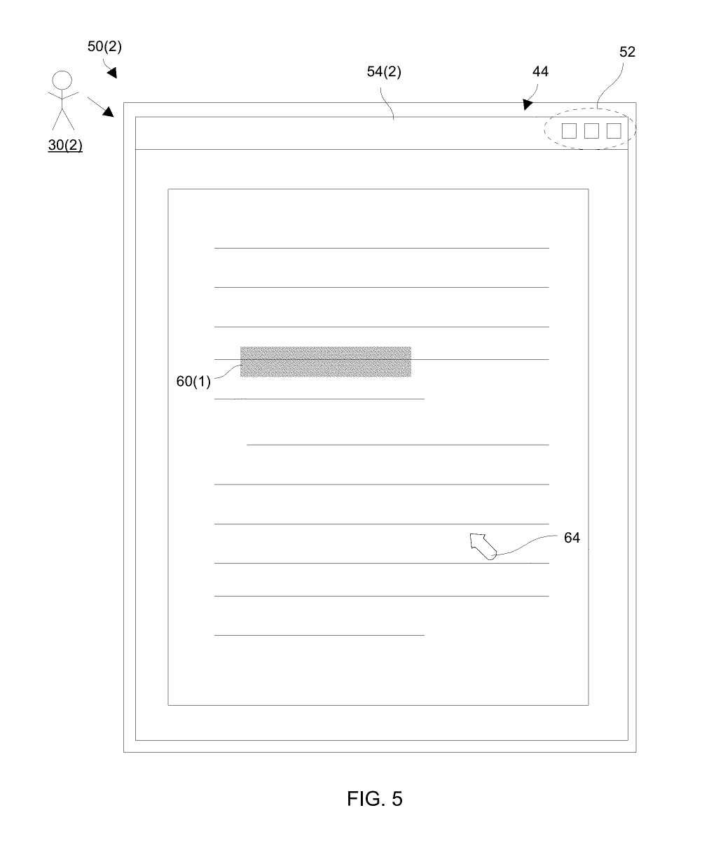

FIGS. 2-5 show the display screens of different client apparatus 22 of the computerized setting 20 of FIG. 1 during an online meeting. In particular, FIGS. 2 and 4 show a screen 50(1) of the client apparatus 22(1) which is operated by the user 30(1). FIGS. 3 and 5 show a screen 50(2) of the client apparatus 22(2) which is operated by the user 30(2). Other users 30 participating in the online meeting have access to respective screens of their client apparatus 22 as well (e.g., see the user 30(3) operating the client apparatus 22(3) in FIG. 1).

Each client apparatus screen 50(1), 50(2) displays a respective view of the same electronic document 44 which is shared among the users 30 during the online meeting. In particular, the views of the document 44 are provided graphically (e.g., in the form of a slide show, an editor, a spreadsheet, a browser, etc.). The views can include standard controls 52, as well as respond to traditional forms of user input such as selection or highlighting of text (e.g., via left clicking and dragging of a computerized mouse, etc.) presenting a drop down menu (e.g., via right clicking over selected text, etc.), and so on. As will now be explained in further detail, the view 54(1) of the document 44 in the screen 50(1) differs from the view 54(2) of the document 44 in the screen 50(2).

As shown in FIG. 2, the user 30(1) of the client apparatus 22(1) adds a public note 40 to a first portion 60(1) of a document 44. Along these lines, the user 30(1) selects the first portion 60(1) using a mouse or a touch pad (e.g., highlights a section of text and then right clicks or taps on that section of text). Then, the user 30(1) types in text (e.g., comments, notes, etc.) and saves that text as a public note 40 (e.g., presses a public note save button, selects a public note save menu option, etc.). The association of the public note 40 with the first portion 60(1) of text, which is made by the client apparatus 22(1), is illustrated by the dashed arrow 62(1) in FIG. 2.

In response to the above-described user entered input, the client apparatus 22(1) saves the public note 40 in a manner which enables the public note 42 to be subsequently accessed via navigation of the document 44. Additionally, the first portion 60(1) of text is highlighted in the view 54(1) to indicate to the user 30(1) that there is a note associated with the first portion 60(1) of text. Moreover, when the user 30(1) subsequently selects the first portion 60(1) of text (e.g., by moving a pointer 64 over the first portion 60(1) of text in the screen 50(1) of the client apparatus 22(1)), the screen 50(1) of the client apparatus 22(1) displays the public note 40 to enable the user 30(1) to view the public note 40, e.g., see the bubble 66 in FIG. 2. Such selection of text (i.e., moving the pointer 64 to hover over the text) essentially operates as a view command by directing the client apparatus 22(1) to display the associated note. Other situations and scenarios are suitable as well (e.g., clicking on text, dragging the pointer 64 across text while holding down a button or key, etc.).

Likewise and as shown in FIG. 3, after the user 30(1) has directed the client apparatus 22(1) to save the public note 40, other users 30 may view the public note 40 provided by the user 30(1). In particular, after the user 30(1) adds the public note 40, the first portion 60(1) of text is becomes highlighted in the view 54(2) to indicate to the user 30(2) that there is a note associated with the first portion 60(1) of text. Additionally, the user 30(2) can select (or activate) the first portion 60(1) of text in the view 54(2) (e.g., by moving a pointer 64 over the portion 60(1) of text in the screen 50(2) of the client apparatus 22(2)). In response to such selection or activation, the screen 50(2) of the client apparatus 22(2) displays the public note 40 to enable the user 30(2) to view the public note 40, e.g., see the bubble 66 in FIG. 3. Accordingly, all users 30 are able to access the information of the public note 40 added by the user 30(1) and thus effectively collaborate during the online meeting.

With reference back to FIG. 3, the user 30(1) of the client apparatus 22(1) also adds a private note 42 to a second portion 60(2) of the document 44. Along these lines, the user 30(1) selects the first portion 60(2) using a mouse, a touch pad, etc. Next, the user 30(1) types in text and saves that text as a private note 42 (e.g., presses a private note save button, selects a private note save menu option, etc.). The association of the private note 42 with the second portion 60(2) of text, which is provided by the client apparatus 22(1), is illustrated by the dashed arrow 62(2) in FIG. 2.

In response to the above-described user entered input, the client apparatus 22(1) saves the private note 42 in a manner which enables the private note 42 to be subsequently accessed via navigation of the document 44. Additionally, the second portion 60(2) of text is highlighted in the view 54(1) to indicate that there is a note associated with the second portion 60(2) of text.

Furthermore, and as shown in FIG. 4, when the user 30(1) selects (or activates) the second portion 60(2) of text (e.g., by moving a pointer 64 over the second portion 60(2) of text in the screen 50(1) of the client apparatus 22(1)), the screen 50(1) of the client apparatus 22(1) displays the information of the private note 42 to enable the user 30(1) to view the private note 42, e.g., see the bubble 68 in FIG. 4.

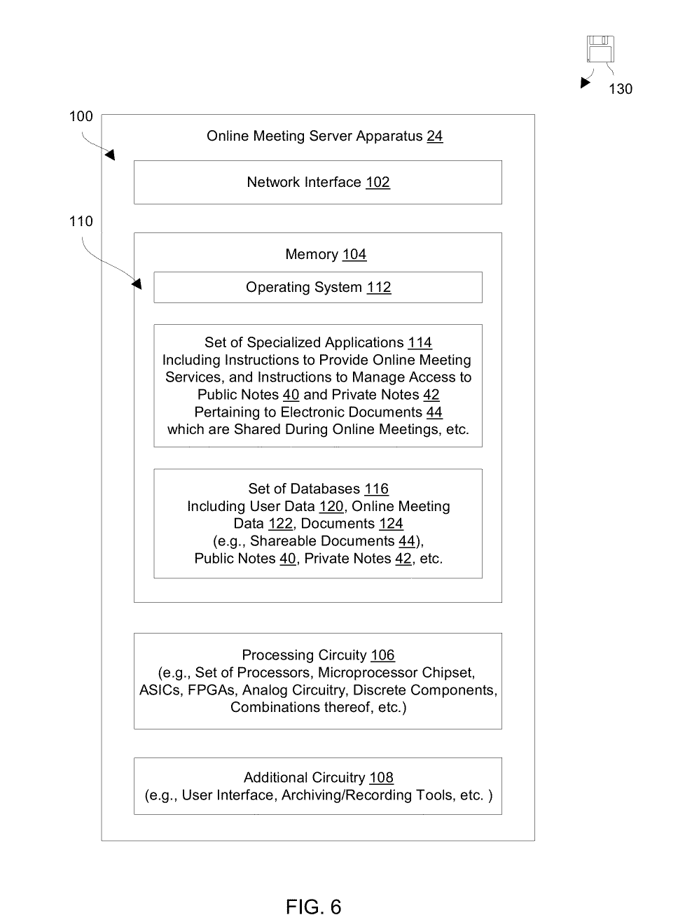

However, after the user 30(1) has directed the client apparatus 22(1) to save the private note 42, other users 30 may not view the private note 42 provided by the user 30(1). For example, as shown in FIG. 5, the second portion 60(2) of text is not highlighted in the view 54(2) because the entry from the user 30(1) is a private note 42. Additionally, the user 30(2) cannot activate the second portion 60(2) of text that was added by the user 30(1) (e.g., by moving a pointer 64 over the portion 60(2) of text which is un-highlighted in the screen 50(2) of the client apparatus 22(2)). As a result, the user 30(2) is not distracted by the private note 42. Further details will now be provided with reference to FIG. 6.

FIG. 6 shows particular details of the online meeting server apparatus 24 which is constructed and arranged to provide online meeting services to the users 30, as well as manage access to public notes 40 and private notes 42 pertaining to electronic documents 44 which are shared during online meetings. The online meeting server apparatus 24 includes a variety of components 100 such as a network interface 102, memory 104, processing circuitry 106, and additional circuitry 108.

The network interface 102 is constructed and arranged to connect the online meeting server apparatus 24 to the communications medium 26. Accordingly, the network interface 102 enables the online meeting server apparatus 24 to communicate with the other components of the computerized setting 20 (FIG. 1). Such communications may be copper-based or wireless (i.e., IP-based, cellular, Bluetooth, combinations thereof, and so on).

The memory 104 is intended to represent both volatile storage (e.g., DRAM, SRAM, etc.) and non-volatile storage (e.g., flash memory, magnetic disk drives, etc.). The memory 104 stores a variety of software constructs 110 including an operating system 112, a set of specialized online meeting applications 114, a set of online meeting databases 116. The set of specialized online meeting applications 114 includes, among other things, (i) instructions to provide online meeting services to the users 30, and (ii) instructions to manage access to public notes 40 and private notes 42 pertaining to electronic documents 44 which are shared during online meetings. The set of online meeting databases 116 includes, among other things, user data 120 to identify the various users 30 (e.g., subscriber data, user profiles, user privileges, etc.), online meeting data 122 (e.g., schedules and meeting identifiers, configuration information, etc.), documents 124 (e.g., shared documents 44, other files, etc.), and public notes 40 and private notes 42 pertaining to the shared documents 44, and so on.

The processing circuitry 106 is constructed and arranged to operate in accordance with the various software constructs 110 stored in the memory 104. In particular, the processing circuitry 104, when executing the operating system 112, manages various resources of the online meeting server apparatus 24 (e.g., memory allocation, processor cycles, etc.). Additionally, the processing circuitry 104 executing the set of online meeting applications 114 forms control circuitry which manages online meetings and hosts online meetings, e.g., the users 30 connect to the online meeting server 24 to join online meetings using their the client apparatus 22 and are thus able to collaborate effectively. Furthermore, such control circuitry is able to access the set of online meeting databases 116 to enable efficient and reliable information access, e.g., so that the users 30 can add public notes 40 and private notes 42 pertaining to shared documents 44, so that the users 30 can access the public notes 40 and private notes 42 during the online meetings and after the online meetings, and so on. For example, the public notes 40 may be accessed by any user 30, even a user 30 that was not present at the online meeting.

The additional circuitry 108 represents specialized hardware, components and peripherals which are capable of performing specialized operations of the online meeting server apparatus 24. In some arrangements, the additional circuitry includes a user interface administrator access, recording and archiving utilities, virtualization and desktop circuitry, project management circuitry, other collaboration circuitry, and so on.

It should be understood that the above-mentioned control circuitry may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 130 is capable of delivering all or portions of the software to the online meeting server apparatus 24. The computer program product 130 has a non-transitory and non-volatile computer readable medium which stores a set of instructions to control one or more operations of the online meeting server apparatus 24. Examples of suitable computer readable storage media include tangible articles of manufacture and apparatus which store instructions in a non-volatile manner such as CD-ROM, flash memory, disk memory, tape memory, and the like.

During operation, the online meeting server apparatus 24 connects with the various client apparatus 22 to host online meetings. In some arrangements, the online meeting server apparatus 24 responds to requests from the client apparatus 22 to join particular meetings based on assigned meeting identifiers (IDs).

During each online meeting, the online meeting server apparatus 24 receives video and audio from the participating client apparatus 22. The online meeting server apparatus 24 then shares the video (e.g., multiple web cameras views, a slide show of a presentation, etc.) and audio (e.g., an aggregate audio signal of all the participants) among the participating client apparatus 22. Accordingly, the participants are able to view visual content, as well as inject comments and ask questions to form a collaborative exchange even though the participants may be scattered among remote locations.

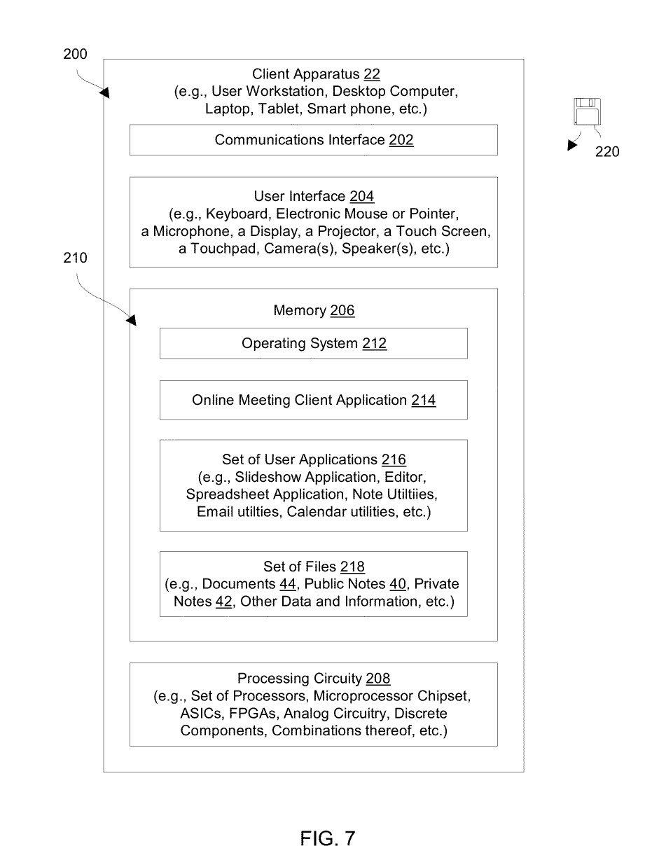

Furthermore, during such meetings, the online meeting server apparatus 24 controls access to the set of databases 116 so that each user 30 is capable of adding public notes 40 to a document 44, and the added public notes 40 are viewable by all users 30 (e.g., see FIGS. 2 and 3). Additionally, the online meeting server apparatus 24 controls access to the set of databases 116 so that each user 30 is capable of adding private notes 42 to a document 44, and the added private notes 42 are viewable only by that user 30, i.e., the user 30 who added the private notes 42 (e.g., see FIGS. 4 and 5). Further details will now be provided with reference to FIG. 7.

FIG. 7 shows particular details of a client apparatus 22 which is constructed and arranged to connect to and operate with the online meeting server apparatus 24 on behalf of a particular user 30. As a result, the particular user 30 is able to engage with others in online meetings, as well as access public notes 40 from all users 30 and private notes 42 of the particular user 30. As shown in FIG. 7, the client apparatus 22 includes a variety of components 200 such as a communications interface 202, a user interface 204, memory 206, processing circuitry 208, and additional circuitry 210. The architecture and/or form factor of the client apparatus 22 may be that of a user workstation, a desktop computer, a laptop or notebook computer, a specialized conferencing system, a tablet device, a smart phone, combinations thereof, etc.

The communications interface 202 is constructed and arranged to connect the client apparatus 22 to the communications medium 30 (FIG. 1). Accordingly, the communications interface 202 enables the client apparatus 22 to communicate with the other components of the computerized setting 20 such as the online meeting server apparatus 24. Such communications may be line-based or wireless (i.e., IP-based, cellular, combinations thereof, and so on).

The user interface 204 is constructed and arranged to receive input from a set of users 30 and to provide output to the set of users 30. The user interface 104 includes a variety of components which may vary depending on the architecture and form factor of client apparatus 22. Such components may include a keyboard, a pointing device (e.g., mouse), a microphone, an electronic display, a projector, a touch screen, a touchpad, a set of cameras, a set of speakers, and so on.

The memory 206 is intended to represent both volatile storage (e.g., DRAM, SRAM, etc.) and non-volatile storage (e.g., flash memory, magnetic disk drives, etc.). The memory 206 stores a variety of software constructs 210 including an operating system 212, an online meeting client application 214, a set of user applications 216, and a set of files 218.

The processing circuitry 208 is constructed and arranged to operate in accordance with the various software constructs 210 stored in the memory 64. In particular, the processing circuitry 208, when executing the operating system 212, manages various resources of the client apparatus 22 (e.g., memory allocation, processor cycles, etc.). Additionally, the processing circuitry 208 executing the online meeting client application 214 forms control circuitry which joins a user 30 of the client apparatus 22 to an online meeting hosted by the online meeting server apparatus 24 to allow the users 30 of the computerized setting 20 to participate in an online meeting. Furthermore, the processing circuitry 208 executing the set of user applications 216 enables the user 30 of the client apparatus 22 to perform various types of work such as presenting a slideshow, navigating and/or editing a document, editing a spreadsheet, adding public notes 40 and private notes 42 to a document, calendars, email utilities, and so on. During such operation, the user 30 may access a set of files 218 which are stored locally on the client apparatus 22 or stored remotely such as on a file server (or in the cloud) or even on the online meeting server apparatus 24.

The control circuitry of the client apparatus 22 may be implemented in a variety of ways including via one or more processors (or cores) running specialized software, ASICs, FPGAs and associated programs, discrete components, analog circuits, other hardware circuitry, combinations thereof, and so on. In the context of one or more processors executing software, a computer program product 220 is capable of delivering all or portions of the software to the client apparatus 22. The computer program product 220 has a non-transitory and non-volatile computer readable medium which stores a set of instructions to control one or more operations of the client apparatus 22. Examples of suitable computer readable storage media include tangible articles of manufacture and apparatus which store instructions in a non-volatile manner such as CD-ROM, flash memory, disk memory, tape memory, and the like.

During operation, the control circuitry of the client apparatus 22 is able to join and participate in online meetings which are hosted by the online meeting server apparatus 22 (FIG. 6). During such a meeting, the user 30 is able to render views of certain applications (e.g., share desktops, display application views, etc.) to other participants 30 of the online meeting. In such a situation, the control circuitry enables the user 30 to add public notes 40 pertaining to a document 44, and provide access to the public notes 40 to the other participants 30. Additionally, the control circuitry enables the user 30 to add private notes 42 pertaining to the document 44, and restrict access to the private notes 42 to only that user 30 (i.e., other participants of the online meeting cannot view the private notes 42).

The above-described private note feature is well suited for a variety of situations. For example, a user 30 may wish to add, as private notes 42, personal notes to a presentation such as a slide show or document under review, and incorporate private notes 42 with that material rather than maintain a separate hardcopy with handwritten personal notes. Here, the user 30 does not need to worry about others viewing the personal notes but nevertheless has them available with the material rather than loose and separate.

It should be understood that the public and private note adding and accessing functionality can be put in place within the computerized setting 20 in a variety of ways. Along these lines, in some arrangements, the particular application that renders content to the online meeting participants (e.g., the slideshow application, the editor application, the spreadsheet, etc.) includes specialized code to manage public notes 40 and private notes 42. Here, a single application is responsible for both rendering the document content as well as capturing notes from the user 30. In one arrangement, the client apparatus 22 while running the rendering application (e.g., a document editing application of the set of user applications 216 in FIG. 7) stores the public notes 40 and private notes 42 as metadata in the file that contains the document information, i.e., the document 44. In another arrangement, the client apparatus 22 while running the rendering application stores the public notes 40 and private notes 42 as metadata in a set of files that is separate from the document 44.

In other arrangements, the particular application that renders content to the online meeting participants (e.g., the slideshow application, the editor application, the spreadsheet, etc.) is separate from the specialized application responsible for managing public notes 40 and private notes 42. In this situation, one application is responsible for rendering the document content, and another application is responsible for capturing notes from the user 30. That is, the client apparatus 22, while concurrently running the document editing application and the specialized application, stores the public notes 40 and private notes 42 as metadata in a set of files that is separate from the document 44 (e.g., see the set of files 218 in FIG. 7).

It should be understood that the document information and the public notes 40 and private notes 42 can be stored in a variety of locations within the computerized setting 20. In one arrangement, the document information and the public notes 40 and private notes 42 are stored locally on the client apparatus 22 (see the set of files 218 in FIG. 7). In another arrangement, the document information and the public notes 40 and private notes 42 are stored remotely on the online meeting server apparatus 24 (see the set of databases 116 in FIG. 6).

In a particular arrangement, the document information and the public notes 40 are stored remotely on the online meeting server apparatus 24, and the private notes 42 are stored separately on the client apparatus 22. Accordingly, the document information and the public notes 40 are conveniently accessible by the other users 30 from the online meeting server apparatus 24. Additionally, the private notes 42 can be stored securely and under tighter control (e.g., with less risk of tampering, copying, etc.) on the client apparatus 22.

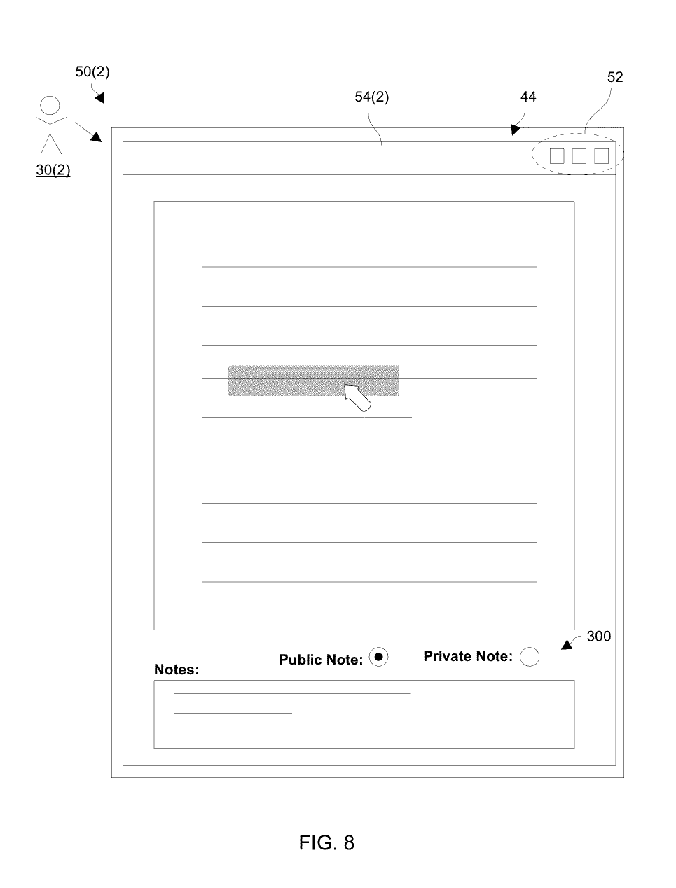

In another particular arrangement, the document information and the public notes 40 and private notes 42 are stored locally on the client apparatus 22 as well as remotely on the online meeting server apparatus 24. Here, the online meeting server apparatus 24 can be relied upon to impose access control such as via access privileges which are managed by the online meeting server apparatus 24 (see the set of specialized applications 114 in FIG. 6). Further details will now be provided with reference to FIGS. 8-10.

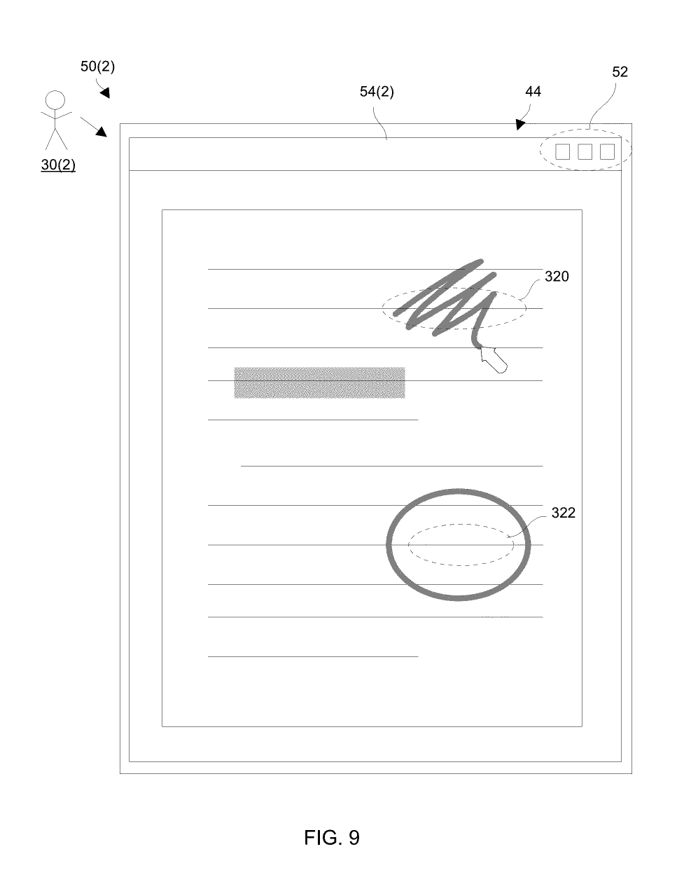

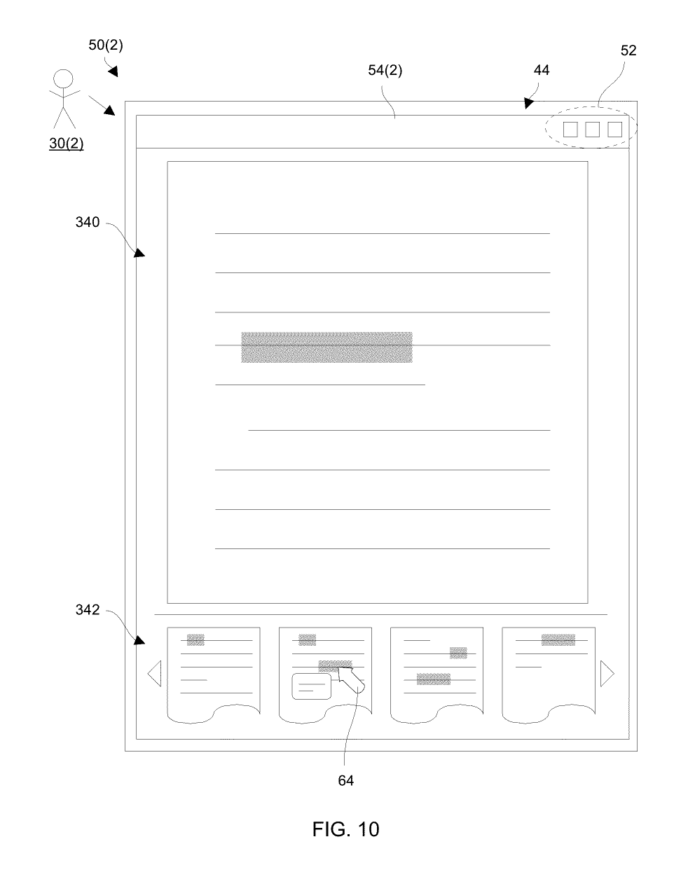

FIGS. 8-10 show additional features provided by the computerized setting 20 (also see FIG. 1). FIG. 8 shows the screen 50(1) of the client apparatus 22(1) which is operated by the user 30(1) when the user 30(1) invokes an interface to direct the client apparatus 22(1) to add a public note 40 or a private note 42 to a particular portion of a document 44. FIG. 9 shows the screen 50(1) when the user 30(1) inputs handwritten notes over areas that the user 30(1) wants to modify. FIG. 10 shows the screen 50(1) when the user 30(1) pulls up a document preview pane to enable the user 30(1) to look ahead (or behind) in the document 44.

With reference to FIG. 8, any user 30 (e.g., the user 30(1)) is able to add public notes 40 and private notes 42 to a document 44 which is shared by the other users 30 during an online meeting (also see FIG. 2). Identification of whether the particular note being added is a public note 40 or a private note 42 can be controlled via user input parameters 300 (e.g., menu selections, radio buttons, right clicking a mouse, preset user preferences, combinations thereof, and so on).

If the user 30 adds a public note 40, other users 30 participating in the online meeting are able to view the public note 40 (also see FIG. 3). However, if the user 30 adds a private note 42, only that user 30 can see the private note 42 (also see FIG. 4); all other users 30 participating in the online meeting are unable to view the private note 42 thus preventing the other users 30 from being distracted by the private note 42 (also see FIG. 5).

It should be understood that each user 30 is able to add public notes 40 and private notes 42 to the document 44. Access to these notes can be managed by the client apparatus 20, the online meeting server apparatus 24, or both (e.g., via access privileges, etc.).

Additionally, it should be understood that a similar split pane view as shown in FIG. 8 is presented to the appropriate users 30 to display certain public notes 40 and private notes 42 that may pertain to the entire document 44, rather than particular text. In particular, public notes 40 pertaining to the entire document 44 are displayed in the lower notes section to all users 30. However, private notes 42 pertaining to the entire document 44 are shown in the lower notes section only to the user 30 that contributed the private notes 42.

With reference to FIG. 9, any user 30 can manually scribble on a document 44. For example, suppose that the user 30(1) wishes to delete one portion 320, and identify another portion 322 as needing further attention or work. In such a situation, the user 30(1) can scribble over the portion 320 to indicate deletion, and circle the other portion 322 that needs further attention.

Such handwritten input can be provided using an electronic mouse (e.g., controlling the pointer), an electronic touch screen or touchpad, and so on. Furthermore, such handwritten input can be identified as a public note 40 or a private note 42 via user input parameters 300. When the handwritten input is identified as a public note 40, other users 30 participating in the online meeting are able to view the public note 40. Alternatively, when the handwritten input is identified as a private note 42, only the user 30 that added the handwritten input can see the private note 42; all other users 30 participating in the online meeting are unable to view the private note 42 thus preventing the other users 30 from being distracted by the handwritten input.

With reference to FIG. 10, a view of the document 44 can be divided into a general viewing area 340, and a document preview pane 342. In particular, any user 30 can invoke the document preview pane 342 and then navigate the document preview pane 342 (e.g., see the right and left arrows in FIG. 10) to view public notes 40 and private notes 42 added by that user 30. For example, if the user 30(1) is presenting material within the document 44 to the other users 30 during an online meeting, the user 30(1) may wish to look ahead at an annotation made in another section of the document 44. Here, the user 30(1) is able to pull up the document preview pane 342 and navigate ahead in the document 44 without disrupting his/her colleagues (i.e., the other users 30 do not see that the user 30(1) has invoked the document preview pane 342 and is looking ahead). Of course, the user 30(1) is able to utilize the document preview pane 342 for other reasons as well (e.g., work off an earlier-entered outline, quick jump/navigate to portions linked to the notes 40, 42, and so on). In some arrangements, the user 30(1) is able to select portions of the document 44 within the document preview pane 342 (e.g., using a mouse, using a touch screen, etc.), and view notes 40,42 within the document preview pane 342 in the same manner as in the general document area 340.

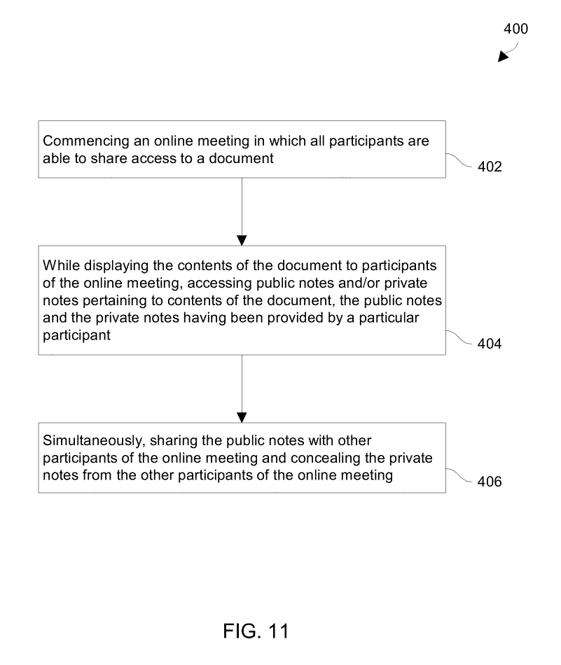

It should be understood that the features of FIGS. 8-10 can be provided by augmenting document applications that are installed on the various components of the computerized setting 20, i.e., the client apparatus 22, the online meeting server apparatus 24, both, etc. Alternatively, the features of FIGS. 8-10 can be provided by running a separate note-gathering application which overlays views (e.g., transparently, semi-transparently, etc.) over the document contents provided by legacy document applications (e.g., the separate note-gathering application may be able to coordinate access via links using APIs to the legacy document applications, etc.). Further details will now be provided with reference to FIG. 11.

FIG. 11 is a flowchart of a procedure 400 which is performed by the computerized setting 20. At 402, the computerized setting 20 commences an online meeting in which all of the participating users 30 (also see FIG. 1) are able to share access to a document 44. In particular, each user 30 operates a respective client apparatus 20 to join the online meeting. For example, some users 30 may direct their desktop computers and table devices to connect to the online meeting over the Internet. Additionally, other users 30 may direct their smart phones to connect to the online meeting over the cellular telecommunications infrastructure. Other users 30, without any video access, may simply dial into the online meeting using the plain old telephone system (POTS).

At 404, the computerized setting 20 provides each user 30 with the ability to access public notes 40 of all the users 30, and private notes 42 of just that user 30. In particular, the client apparatus 20 of each user 30, while displaying contents of the document 44 to participants of the online meeting to that user 30, accesses the public notes 40 and private notes 42 pertaining to the contents of the document 44. Such access may be controlled via access privileges which are imposed by the computerized setting 20 (e.g., see the applications 114, 214, 216 in FIGS. 6 and 7).

At 406, the computerized setting 20 concurrently shares the public notes 40 with other participants of the online meeting, and conceals the private notes 42 from the other participants of the online meeting. Accordingly, the users 30 are able to share public notes 40 with all of the participants to enrich the online meeting (e.g., all users 30 can see final decisions on next steps and action items, etc.). Furthermore, only the user 30 adding the private notes 42 can see the private notes 42 added by that user 30 (e.g., other users 30 are not bothered by private annotations made by the user 30).

Moreover, upon conclusion of the online meeting, each user 30 is able to store the public notes 40 and the private notes 42 as metadata associated with the contents of the document 44 (e.g., locally on the client apparatus 22, on the online meeting server apparatus 24, or both). Accordingly, each user 30 is enable access these notes 40, 42 in the future.

As described above, improved techniques are directed to managing access to public notes 40 and private notes 42 pertaining to contents of a document 44 while the contents of the document 44 are displayed to participants of an online meeting. In particular, public notes 40 provided by a particular participant 30 are shared with other participants 30. However, private notes 42 provided by the particular participant 30 are concealed from the other participants 30. Since the private notes 42 are not shared with the other participants 30, the private notes 42 do not distract the other participants 30 thus improving the user experience for all involved in the online meeting.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the computerized setting 20 are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

Additionally, it was described above that other users 30 may view public notes 40 once the contributing user 30 saves the public notes 40 by way of example only. In other arrangements, the other users 30 are able to see the public notes 40 while the contributing user 30 is typing the public notes 40.

Furthermore, in some arrangements, the users 30 are able to view the notes 40, 42 in different manners, and such viewing capabilities may be selectable. For example, some users 30 may view notes 40, 42 as bubbled comments, other users 30 may view notes 40, 42 only when moving a pointer over highlighted text, and yet other users 30 may view notes 40, 42 in a separate window or pane (e.g., at the bottom or top, along the side, etc.), and so on.

Additionally, a document preview pane 342 was described above as being displayable to the appropriate users 30 in connection with FIG. 10. In other arrangements, the document preview pane 342 is not displayed on the primary user display. Rather, in these arrangements, one or more users 30 are equipped with a helper or secondary device (e.g., a tablet, a smart phone, another local user device, etc.), and the document preview pane 342 is displayed only on the helper device.

Furthermore, it should be understood that the above-described note-gathering features can be provided on a variety of different platforms, apparatus and/or devices. Once such features are made available (e.g., via processing circuitry running specialized software), a user 30 can invite other users 30 to an online meeting. The attendees join the online meeting and direct their client apparatus 22 run copies of the specialized software. As a result, the clients apparatus 22 enable each user 30 to collaborate with other online users 30. In some arrangements, the interaction amongst the instances of the specialized software running by the users 30 in a meeting are done via a server infrastructure or peer-to-peer over the intranet/internet.

In particular, the users 30 can make private notes 40 and public notes 42 and annotations on a document 44 being shared in the meeting. As a result, each user 30 can have both public and private views of the document 44 being shared.

In some arrangements:

A presenter decides to share a document with attendees during an online session.

Attendees can see and discuss the document with the presenter.

The presenter can take notes on the document that all attendees can view and take away with them.

The presenter can take notes on the document that only he can see and are saved only for him.

The presenter and attendees can take public or private notes on the meeting in general and those notes are saved.

The presenter can skip ahead in document preview mode to see what is coming up. This preview is only visible to him.

Meeting attendees can see notes in context of the document after the session.

In some situations, when a document is shared, a client apparatus 22 allows a user 30 to add private notes which are overlaid over the document in a semi-transparent window/callout with a distinctive color and background. Such a feature allows the user 30 to add public notes 40 to the document 44, overlaid on a view of the document 44 using a semi-transparent window/callout with a distinctive color and background, different from the private notes window.

It should be understood that there are a variety of ways to provide such features. One way is to integrate this into a document handling application itself. Another way is to have a standalone application that works alongside any document management application.

In the first situation, the note functionality is part of the document editing and rendering application. Along these lines, when a document 44 is shared, the application allows the user to add private notes 42 which are overlaid over the document 44 in a semi-transparent window/callout with a distinctive color and background. These private notes 42 are not sent to the other users applications unless the author decides to make them public. The running application allows the user to add public notes 40 to the document 44, overlaid on the document 44 using a semi-transparent window/callout with a distinctive color and background, different from the private notes window. These notes are sent to the other user's applications, which render them with the document 44. When the meeting ends, the attendees of the meeting can each save a copy of the document 44 with their private notes, and all the public notes. For implementing preview, the application merely has to render the preview in another window or even on a helper device such as the user's smartphone or tablet. The helper device will be running the note gathering application, and the user will have authenticated and assigned that device as a helper device for that meeting. Saving the notes can be easily implemented by either adding them into the document 44, or saving them in a separate file/files. This functionality can also be implemented with the document saved in the cloud, in which case the notes are all saved in the cloud, with the document 44. Access controls are used to make sure a user only sees the public notes and their own private notes.

In the second situation, the note-gathering functionality is provided in a separate application from the document handling application. Here, the application works in general with any document editing and viewing application. For sharing a document, the separate note-gathering application starts the document viewing and editing application and then take visual snapshots of its window and sent it to the attendees' note-gathering application instances. When a document 44 is shared, the application allows the user to add private notes 42 which are overlaid over a view of the document 44 in a semi-transparent window/callout with a distinctive color and background. Since the visual snapshot is done for the document application window only, the private notes window will not be captured as part of it and hence the notes will stay private unless the user's note-gathering application sends them to the other users' note-gathering application instances. Furthermore, the application allows the user to add public notes 40 to the document, overlaid on the document using a semi-transparent window/callout with a distinctive color and background, different from the private notes window. These public notes 40 are sent to the attendees' note-gathering application instances, where they are rendered appropriately to overlay the document application view. For implementing preview, the note-gathering application silently creates a copy of the document 44 being presented, and opens the copy of the document to the user for previewing. If the preview user interface (UI) needs to be custom, the note-gathering application may run the application in a hidden mode and capture the window snapshot and display it locally in the custom UI. Additionally, the preview window snapshots can be sent to the user's helper device which is running the note-gathering application (the user will have authenticated and assigned that device as a helper device for that meeting). One implementation to saving such notes is to take snapshots and overlays and save them as a series of images. Another is to save notes with metadata about which document and page they refer to. Then have a custom viewer that renders the document and the notes overlaid on it.

One should appreciate that in connection with conventional web conferences, while users have digital documents available to them, they frequently print out and interact with the paper copies to take notes or have the freedom to look read ahead without getting others off track. As a presenter, when going through a document with others, there is a need to check something further ahead in the document or take a personal note on the document, and to do so without others in the meeting seeing this activity.

However, with the improved techniques, presenters are able to preview upcoming pages of the shared document 44. Additionally, the presenter is able to take public notes 40 and private notes 42. Furthermore, the attendees are able to take public notes 40 and private notes 42. Moreover, the attendees can “scribble” on the presentation (annotate it) and save those changes (see FIG. 9). Such modifications and enhancements are intended to belong to various embodiments of the disclosure.

What is claimed is:

1. A method of managing notes pertaining to a document during an online meeting, the method comprising:
while displaying contents of the document to participants of the online meeting, accessing, by processing circuitry, public notes and private notes pertaining to the contents of the document, the public notes and the private notes having been provided by a particular participant;
sharing, by the processing circuitry, the public notes with other participants of the online meeting; and
concealing, by the processing circuitry, the private notes from the other participants of the online meeting.

2. A method as in claim 1, further comprising:
upon conclusion of the online meeting, storing the public notes and the private notes as metadata associated with the contents of the document to enable future note access.

3. A method as in claim 2 wherein sharing the public notes with the other participants of the online meeting includes:
displaying certain text of the document in a highlighted manner to the other participants of the online meeting, and
while displaying the certain text of the document in the highlighted manner, receiving a view command from one of the other participants to view a public note pertaining to the certain text and, in response to the view command, rendering the public note pertaining to the certain text to that one of the other participants.

4. A method as in claim 2 wherein concealing the private notes from the other participants of the online meeting includes:
displaying certain text of the document in a non-highlighted manner to the other participants of the online meeting, and
while displaying the certain text of the document in the non-highlighted manner to the other participants of the online meeting, receiving a view command from the particular participant to view a private note pertaining to the certain text and, in response to the view command, rendering the private note pertaining to the certain text to the particular participant and not rendering the private note pertaining to the certain text to the other participants.

5. A method as in claim 2 wherein sharing the public notes with the other participants of the online meeting includes:
displaying first text of the document in a highlighted manner to all participants of the online meeting, and
while displaying the first text of the document in the highlighted manner, receiving a view command from one of the other participants to view a public note pertaining to the first text and, in response to the view command, rendering the public note pertaining to the first text to the one of the other participants; and
wherein concealing the private notes from the other participants of the online meeting includes:
displaying second text of the document in a highlighted manner to the particular participant of the online meeting and in a non-highlighted manner to the other participants of the online meeting, and
while displaying the second text of the document, receiving a view command from the particular participant to view a private note pertaining to the second text and, in response to the view command, rendering the private note pertaining to the second text to the particular participant and not rendering the private note pertaining to the second text to the other participants.

6. A method as in claim 5 wherein displaying the first text of the document in the highlighted manner to all participants of the online meeting includes rendering the first text to the particular participant in a first color; and
wherein displaying the second text of the document in the highlighted manner to the particular participant of the online meeting includes rendering the second text to the particular participant in a second color which is different than the first color.

7. A method as in claim 5, further comprising:
receiving freestyle drawn notes from the particular participant and storing the freestyle drawn notes as additional metadata associated with the contents of the document to enable future access to the freestyle drawn notes.

8. A method as in claim 2 wherein concealing the private notes from the other participants of the online meeting includes:
displaying a look-ahead pane to the particular participant and not displaying the look-ahead pane to the other participants, the look-ahead pane including the private notes.

9. A method as in claim 2 wherein the particular participant connects a local user device to an online meeting server to join the online meeting; and wherein storing the public notes and the private notes as the metadata associated with the contents of the document includes:
saving, on the online meeting server, (i) first metadata containing the public notes, the first metadata being readable by any of the participants from the online meeting server, and (ii) second metadata containing the private notes, the second metadata being readable from the online meeting server by the particular participant and not readable from the online meeting server by the other participants.

10. A method as in claim 2 wherein the particular participant connects a local user device to an online meeting server to join the online meeting; and wherein storing the public notes and the private notes as the metadata associated with the contents of the document includes:
saving first metadata containing the public notes on the online meeting server to enable reading of the first metadata by any of the participants, and
saving second metadata containing the private notes on the local user device to enable reading of the second metadata by only the particular participant.

11. A method as in claim 2 wherein the contents of the document are displayed via a shared document application with integrated note management capabilities; and wherein storing the public notes and the private notes as the metadata associated with the contents of the document includes:
conveying a save command to the shared document application with the integrated note management capabilities which saves the metadata in non-volatile memory in response to the save command.

12. A method as in claim 2 wherein the contents of the document are displayed via a shared document application; and wherein storing the public notes and the private notes as the metadata associated with the contents of the document includes:
conveying a save command to a separate overlay application which overlays a shared workspace screen transparently over the contents of the document displayed via the shared document application, the separate overlay application saving the metadata in non-volatile memory in response to the save command.

13. An electronic apparatus, comprising:
a network interface;
memory; and
control circuitry coupled to the network interface and the memory, the memory storing instructions which, when carried out by the control circuitry, cause the control circuitry to:
while displaying contents of a document to participants of an online meeting, access public notes and private notes pertaining to the contents of the document, the public notes and the private notes having been provided by a particular participant,
share the public notes with other participants of the online meeting, and
conceal the private notes from the other participants of the online meeting.

14. An electronic apparatus as in claim 13 wherein the control circuitry is constructed and arranged to:
upon conclusion of the online meeting, store the public notes and the private notes as metadata associated with the contents of the document to enable future note access.

15. An electronic apparatus as in claim 14 wherein the control circuitry, when sharing the public notes with the other participants of the online meeting, is constructed and arranged to:
display first text of the document in a highlighted manner to all participants of the online meeting, and
while displaying the first text of the document in the highlighted manner, receive a view command from one of the other participants to view a public note pertaining to the first text and, in response to the view command, render the public note pertaining to the first text to the one of the other participants; and
wherein the control circuitry, when concealing the private notes from the other participants of the online meeting, is constructed and arranged to:
display second text of the document in a highlighted manner to the particular participant of the online meeting and in a non-highlighted manner to the other participants of the online meeting, and
while displaying the second text of the document, receive a view command from the particular participant to view a private note pertaining to the second text and, in response to the view command, render the private note pertaining to the second text to the particular participant and not render the private note pertaining to the second text to the other participants.

16. An electronic apparatus as in claim 15 wherein the control circuitry, when displaying the first text of the document in the highlighted manner to all participants of the online meeting, is constructed and arranged to render the first text to the particular participant in a first color; and
wherein the control circuitry, when displaying the second text of the document in the highlighted manner to the particular participant of the online meeting, is constructed and arranged to render the second text to the particular participant in a second color which is different than the first color.

17. A computer program product having a non-transitory computer readable medium which stores a set of instructions to manage notes pertaining to a document during an online meeting, the set of instructions, when carried out by computerized circuitry, causing the computerized circuitry to perform a method of:
while contents of the document are displayed to participants of the online meeting, accessing public notes and private notes pertaining to the contents of the document, the public notes and the private notes having been provided by a particular participant;
sharing the public notes with other participants of the online meeting; and
concealing the private notes from the other participants of the online meeting.

18. A computer program product as in claim 17 wherein the method further comprises:
upon conclusion of the online meeting, storing the public notes and the private notes as metadata associated with the contents of the document to enable future note access.

19. A computer program product as in claim 18 wherein sharing the public notes with the other participants of the online meeting includes:
displaying first text of the document in a highlighted manner to all participants of the online meeting, and
while displaying the first text of the document in the highlighted manner, receiving a view command from one of the other participants to view a public note pertaining to the first text and, in response to the view command, rendering the public note pertaining to the first text to the one of the other participants; and
wherein concealing the private notes from the other participants of the online meeting includes:
displaying second text of the document in a highlighted manner to the particular participant of the online meeting and in a non-highlighted manner to the other participants of the online meeting, and
while displaying the second text of the document, receiving a view command from the particular participant to view a private note pertaining to the second text and, in response to the view command, rendering the private note pertaining to the second text to the particular participant and not rendering the private note pertaining to the second text to the other participants.

20. A computer program product as in claim 19 wherein storing the public notes and the private notes as the metadata associated with the contents of the document includes:
saving first metadata containing the public notes to enable reading of the first metadata by any of the participants, and
saving second metadata containing the private notes to enable reading of the second metadata by only the particular participant, the second metadata having a different access privilege than the first metadata to prevent the other participants from accessing the private notes.
